(19) United States
(12) Patent Application Publication
(10) Pub. No.: US 2020/0170200 A1
(43) Pub. Date: Jun. 4, 2020

(54) SYSTEM AND METHOD FOR MODIFYING INTENSITY OR PATH OF A TROPICAL CYCLONE

(71) Applicants: John Barton Huber, Sebring, FL (US); Kenneth L. Walter, Sebring, FL (US)

(72) Inventors: John Barton Huber, Sebring, FL (US); Kenneth L. Walter, Sebring, FL (US)

(21) Appl. No.: 16/533,369

(22) Filed: Aug. 6, 2019

Related U.S. Application Data
(60) Provisional application No. 62/740,315, filed on Oct. 2, 2018.

(51) Int. Cl. A01G 15/00; G05D 1/02; G05D 1/12

(52) U.S. Cl. CPC A01G 15/00; G05D 1/12; G05D 1/0206

(57) ABSTRACT

A method for modifying the intensity and/or the path of a tropical cyclone is described. In some examples, the method can include employing nuclear submarines to intercept and redirect strong currents beneath a tropical cyclone's eyewall back up to a surface of the water body under the tropical cyclone eyewall. The method can also include imposing submarine-induced short period waves in a leading sector of an outer eyewall of the tropical cyclone, thereby causing a shift in the wind stream and accompanied with a change in the track of the tropical cyclone as well as a reduction in the tropical cyclone's intensity. In another example, the method can include imposing the wind resistance evenly across one or more radial segments of the eyewall of the storm or bilaterally at both leading sectors of the storm for reducing the storm's intensity, but without influencing the storm's path.

### RELATED APPLICATIONS

This application claims the benefit of U.S. Application No. 62/740,315, entitled “Method for Modifying the Intensity and Track of a Hurricane,” and filed on Oct. 2, 2018, which is incorporated herein by reference in its entirety, and the benefit of U.S. application Ser. No. 16/533,369 having the same title and filed Aug. 6, 2019 which is incorporated herein by reference in its entirety.

### SUMMARY

### Preface

In addition to defining a hurricane's center, the hurricane eyewall also plays a pivotal role in fueling the storm by propelling huge amounts of water vapor several miles into the upper atmosphere (the grey colored column on the left of FIG. 1 represents one sector of the eyewall). The coordinated and synchronous movement within the eyewall corridor, (i.e., its circular annular cross-section containing the highest speed winds per FIG. 9) is essential to the storm's efficiency, its ability to intensify, and is surprisingly its Achilles heel in that it harbors the greatest concentration of the storm's immense energy. A sustained disruption in the horizontal contours of the synchronous spinning eyewall has both the potential of altering the storm's ability to further intensify and the potential of altering the track it follows across the earth's surface. Disruptions to that coordinated and synchronous eyewall swirl are more likely to prove significant in altering the storm's track when imposed within its leading quadrants than within its trailing quadrants. The two leading quadrants are those from 9 o'clock through 12 o'clock and from 12 o'clock through 3 o'clock, measured with 12 o'clock representing the storm's current track. Any attempted intervention within the trailing quadrants of the eyewall would prove more difficult in that the storm's forward movement along its current track would always be withdrawing those trailing quadrants away from any attempted intervention.

### I. SUMMARY

The waves of a powerful hurricane eyewall offer minimal wind resistance largely because they are moving in the same direction as the winds, having been driven in essentially the same direction for many miles by eyewall wind speeds of 90 to 190 mph. One approach to hurricane mitigation would be directed at steering the storm onto a less ominous course by restoring an erratic, wind-slowing water surface at a vulnerable point of course deflection on the eyewall perimeter. Large displacement nuclear submarines would maintain a position within the uppermost strong rotating currents that are vertically stacked beneath the long fetch wave crests of the hurricane's eyewall (FIG. 7). That submarine intervention will restructure the wave profiles both by deflecting the high-energy, rotating currents back to the surface and by weakening the foundational support they provide for the very tall wave crests of the mature eyewall. Long period waves will be replaced at a vulnerable point of storm course deflection with short period waves having cross swells and opposing swells that offer significant wind resistance. When continuously carried out at a vulnerable point of course deflection such as at 10 o'clock within the very edge of the outer eyewall, such operations will impose a concavity or at least a flattening in the curvature of the outer eyewall as its wind corridor diverts away from the increased friction forces at the air-sea exchange and away from the increased undersea drag forces also being applied at the 10 o'clock position. (FIG. 8). The symmetry that is inherent in the laws of nature and specifically inherent in the laws of conservation of angular momentum and conservation of energy are dominant features of the hurricane eyewall. In the face of ongoing corridor disruption, such naturally occurring forces along with a compatible Coriolis effect will trigger ongoing resynchronizations that realign the eyewall wind corridor, restore lost symmetry, and shift the eyewall position to the right (in the northern hemisphere; in the southern hemisphere, the shift would be to the left). With that, the center of the storm itself will incur an ongoing course correction to the right, e.g., into the cooler north Atlantic. Interventions at 2 o'clock within the very edge of the inner eyewall adjacent to the calm of the storm's eye could have the same vectoring effect under somewhat less difficult operating conditions. These operations at a leading quadrant will also serve to concurrently mitigate storm intensity by inducing the energy-zapping resynchronizations and by slowing the rate of storm intensification that thrives on compatible waves moving in the same direction as the eyewall winds.

### II

A second approach to hurricane mitigation would slow the eyewall winds of a cyclonic storm by imposing wind absorbing and/or wind deflecting mechanisms mounted on the decks of nuclear aircraft carriers. When continuously carried out at a vulnerable point of course deflection within the very outer edge of an eyewall's leading quadrant, e.g., at 10 o'clock on the storm's present track, the enhanced wind resistance at the air/sea interchange will impose a flattening or concavity in the outer edge of the eyewall at that location. The eyewall wind corridor will shift to the right in an adjusted position away from the obstruction. Symmetry, the laws of conservation of angular momentum and conservation of energy, together with a compatible Coriolis effect, will cause the eyewall to resynchronize and resume a symmetrically circular form. With the continued shift of the storm's center to the right, its course will then also continue to shift to the right. These operations at a leading quadrant will also serve to concurrently mitigate storm intensity by inducing those energy-zapping resynchronizations.

### III

The normal surface tension of clean water enhances the wind's ability to gain a purchase on the water surface, transfer wind momentum, and impart motion to that surface in the form of wave action. In the face of moderate eyewall wind speeds, surface tension is a good thing in that it helps to mitigate storm intensity by assisting the development of erratic wave action that slows eyewall wind speeds. Surface tension within the waters of a hurricane eyewall becomes a bad thing at the 72 mph-89-mph thresholds when extremely high waves with long wave lengths start to evolve, and most significantly provide progressively less wind resistance by adopting the same direction as the wind. Normal levels of surface tension help to hold such developing high waves together despite the tendency of the wind to blow them apart. A third hurricane mitigation approach would employ surfactants once a threshold wind speed has developed. Nuclear-powered vessels operating either at or below the water surface will spread environmentally neutral surfactants that lower surface tension and help the wind to blow apart and retard the further development of high wave profiles with long sweeping spans between crests. When applied within the very outer edge or within the very inner edge of an eyewall leading quadrant, surfactants will help to disrupt eyewall symmetry, induce energy-zapping resynchronizations, and shepherd the storm's track. This mitigation method can also be employed together with other mitigation methods designed to increase wind resistance at the edge of a leading quadrant and impose a flattening or concavity in the outer or inner eyewall.

### IV

The above-described interventions employing submarines, aircraft carriers, and/or surfactants can lessen the storm's intensity, lessen its pace of intensification, and slow its forward pace along its track without significantly altering the ensuing direction taken by the storm if carried out in a balanced manner at two offsetting locations, e.g., both at 11 o'clock and 1 o'clock within the very edge of the outer eyewall.

### V

Once the 72-89 mph threshold has been reached whereby short period waves begin a transformation into long period waves moving in the same direction as the eyewall winds, an intensification fast-track results that enables lower category hurricanes to more quickly advance to the highest category wind speeds. A fifth approach to hurricane mitigation would seek to slow the pace of hurricane intensification by restoring an erratic, wind-slowing water surface across a substantial portion of one or more eyewall radii through a broader application of one or more of the above described interventions between the inner and outer edges of the eyewall.

### VI

A sixth mitigation approach would disrupt hurricane intensification by interfacing large displacement nuclear submarines at the thermocline between the cooler waters below and the layer of warm water above that extends from the ocean surface as far as 300 feet down to the thermocline. This disruption would engage the very bottom of the vertically stacked, rotating currents that churn below the eyewall wave crests (FIG. 7). This submarine implemented mitigation would be applied broadly across a substantial portion of one or more eyewall radii in order to mix the cooler water below the thermocline with the warm water layer above the thermocline. This would ideally lower the average temperature of the warm water layer below the already attained hurricane vaporization threshold of 82F, or at least lessen that average temperature so as to moderate the rate of vaporization at the surface.

### VII

In a seventh approach to hurricane mitigation, environmentally neutral surfactants that lower surface tension would be deployed offshore of coastal cities in order to lower the wave height component of a storm surge. Surfactants should not only serve to lower storm surge wave heights but also serve to lessen the eyewall's capacity to raise the mean sea level component of a storm surge. One method of application would require the construction of remotely controlled fixed stations that would timely dispense environmentally neutral surfactants at the most effective distances from the coastline and with a suitable spacing between adjacent stations that is proportionate to their distances from the shore (e.g., FIG. 10). Another method of surfactant application would employ versatile vessels (capable of safe offshore operations) in the midst of the fierce onshore winds and waves of a hurricane's eyewall and those of the storm bands of the storm's right quadrant.

### VIII

In an eighth approach, telescoping wind turbines turning on a vertical axis would be mounted offshore of coastal cities on the same fixed stations as in para. 11 in order to slow the surface winds, and lessen both the wave height component and the mean sea level component of a storm surge.

These eight methodologies can be employed to steer a storm onto a less ominous course, to lessen storm intensity, to retard the pace of storm intensification, to slow the storm's pace of advancement along its course, and to lessen the storm surge along coastal areas.

Some implementations include a method to reduce intensity of a hurricane or tropical storm. Despite the large size and high captive energy of hurricanes, hurricanes may have at least one vulnerable location: a “steering helm” section located along the outer edge of the leading side of the eyewall and possibly along the inner edge of the leading side of the eyewall that, with manipulation, may permit some degree of steering control. Using an implementation of the disclosed technique, hurricanes may be steered by one or more techniques to manipulate the steering helm section of the eyewall to steer the hurricane or storm (e.g., into cooler waters of the North Atlantic ocean instead of permitting the hurricane or tropical storm to strike a devastating blow to the U.S. mainland or to one or more islands of the Caribbean).

In some implementations, a method for reducing intensity of the tropical cyclone can include deploying nuclear submarines in a water body below an outer edge of a leading side of an eyewall of the storm to reduce its capacity to intensify by one or more of: mimicking a rising floor of the water body, distorting circular symmetry of the outer edge of the leading eyewall of the storm (e.g., at or near a steering helm section) and triggering periodic resynchronizations, inducing short period wave action underneath the outer edge of the leading eyewall (e.g., at or near a steering helm section) of the storm to increase wind resistance by deflecting revolving currents back up to a surface of the water body, deflecting cool ocean water below the thermocline upward to reduce surface water temperature, equipping the nuclear submarines with one or more of water jet systems or air jet systems to assist with control of the vessel's attitude and deflect rotating currents back up to the surface of the water body, deploying nuclear aircraft carriers within an outer edge of a leading side of an eyewall of the tropical storm (e.g., at a steering helm or leading quadrant) to impose wind resistance, or using eyewall management techniques described herein to prevent or delay storm intensification to the higher category hurricanes by one of maintaining or restoring wind-resisting short period waves and preventing non-wind-resisting long period waves that move in the same direction as the eyewall winds. As used herein, a tropical cyclone or storm can be one or more of a hurricane, a typhoon, or a cyclone, or other similar weather phenomena.

In some implementations, a method can include causing enhanced wind resistance induced by erratic wave action at a steering helm location, which can include a sector near the 10 o'clock location of the outer edge of the leading side of the eyewall of the storm, to trigger flattening in the curvature of the eyewall to divert the path of the storm in a rightward direction from its current path (in Earth's northern hemisphere). Clock dial locations are used herein to describe the approximate position around a circular object (e.g., a hurricane or tropical storm eyewall). The clock dial locations are based on the direction of travel of the hurricane or tropical storm being the 12 o'clock position. (FIG. 8)

The method can also include causing a sustained diversion of the wind stream of the outer eyewall of the tropical storm or hurricane to reposition a center of an eye in the rightward direction and deflect a path of the storm to the rightward direction (in the Earth's northern hemisphere).

In some implementations, the method can include causing enhanced wind resistance induced by erratic wave action at a sector near the 2 o'clock position sector of an inner eyewall of the storm to trigger a flattening of the eyewall curvature and divert a forward path of the tropical storm in a rightward direction from its current path (in Earth's northern hemisphere) The method can also include causing a sustained diversion of wind stream of the outer eyewall of the tropical cyclone near 2 o'clock to reposition a center of an eye in the leftward direction and deflect a path of the tropical storm to the leftward direction in the Earth's northern hemisphere. The method can also include causing a sustained diversion of wind stream of the inner eyewall of the tropical cyclone near 10 o'clock to reposition a center of an eye in the leftward direction and deflect a path of the tropical storm to the leftward direction (in Earth's northern hemisphere).

In some implementations, the method can include inducing, using one or more nuclear submarines, erratic short period wave action within the outer eyewall of the tropical storm to increase wind resistance in a corresponding portion of the outer eyewall of the tropical cyclone; reducing the capacity of the tropical cyclone to intensify by distorting circular symmetry of the outer eyewall of the tropical cyclone; and simultaneously causing, in a balanced manner, enhanced wind resistance via deployment of the nuclear submarines on paths crossing beneath the radii of the eyewall of the tropical cyclone to reduce wind speeds and mitigate intensity of the storm without influencing its path.

In some implementations, the method can also include inducing, using nuclear submarines, erratic short period wave action within the outer eyewall of the tropical cyclone to increase wind resistance in corresponding portions of the outer eyewall of the storm; reducing the capacity of the storm to intensify by distorting the circular symmetry of the outer eyewall of the storm; and causing simultaneously and in a balanced manner enhanced wind resistance within the outer eyewall of the tropical cyclone via deployment of the nuclear submarines at leading sectors of a path of the storm to reduce wind speeds and mitigate intensity of the tropical without influencing its path.

In some implementations, the method can include operating the nuclear submarines at an inner portion of the eyewall of the storm (e.g., near a 2 o'clock position) to produce a flattening of the inner portion of the eyewall at the 2 o'clock position and, thus, deflecting a path of the storm to a rightward direction. In some other implementations, the method can include operating the nuclear aircraft carriers at an inner portion of the eyewall of the tropical cyclone at the 2 o'clock position to produce a flattening of the inner portion of the eyewall at the 2 o'clock position and deflecting a path of the storm in a rightward direction.

In some implementations, the method can include causing enhanced wind resistance by operating numerous wind turbines mounted on the decks of nuclear aircraft carriers rotating on their vertical axis to absorb, slow, and deflect the wind so as to trigger a deflection of an outer eyewall wind corridor resulting in an inward flattening of the tropical storm eyewall and a diversion of a path of the storm in a rightward direction to an initial path of the tropical cyclone (in Earth's northern hemisphere) The method can also include causing a sustained diversion of the wind stream of the outer eyewall of the storm to reposition a center of an eye in the rightward direction and deflect a path of the storm to the rightward direction (in Earth's northern hemisphere) (FIG. 8, with nuclear aircraft carriers replacing the nuclear submarines)

In some implementations, the method can include causing enhanced wind resistance at a 2 o'clock sector of an inner eyewall of the tropical cyclone to trigger a flattening of the eyewall curvature and divert a forward path of the tropical storm in a rightward direction from an initial path of the storm in Earth's northern hemisphere. The method can also include causing a sustained diversion of wind stream of the eyewall of the tropical cyclone to reposition a center of an eye of the storm in the leftward direction and deflect a path of the storm to the leftward direction in the Earth's northern hemisphere through operations at 2 o'clock within the outer eyewall edge or at 10 o'clock within the inner eyewall edge.

In some implementations, the method can include increasing wind resistance at the outer edge of the eyewall of the tropical cyclone using wind-absorbent, wind-slowing, and wind-deflecting wind turbines and other structures installed on the decks of nuclear aircraft carriers, wherein the wind turbines turn on a vertical axis mounted on vertical columns. The method can also include introducing simultaneously in a balanced manner wind resistance within the outer eyewall of the storm via deployment of the nuclear aircraft carriers on paths crisscrossing the eyewall radii to reduce wind speeds and mitigate storm intensity without influencing a path of the storm. In some implementations, the method can include introducing simultaneously in a balanced manner wind resistance within the outer eyewall of the tropical storm via deployment of the nuclear aircraft carriers at off-setting locations, or at other than at a leading sector on a current path of the tropical cyclone to reduce wind speeds and mitigate storm intensity without influencing a path of the storm.

In some implementations, a method for modifying a path of a storm can include manipulating the path of the storm across a water body by one of deforming a circular shape of the eyewall of the storm or imposing wind-resisting forces at an outer eyewall of one or more leading sectors of the storm in a direction of the path of the storm. The storm can be one or more of a tropical storm, a hurricane, a typhoon, or a cyclone.

In some implementations, a method for one or more of modifying a path of a storm or reducing intensity of the storm can include applying surfactants to a surface of a water body beneath the storm or introducing disruptive influences by deploying nuclear submarines below an outer eyewall of the tropical storm such that the nuclear submarines rim in close proximity, either abreast or inline on a parallel course beneath one of adjoining or nearby separated wave crests. The storm can be one or more of a tropical storm, a hurricane, a typhoon, or a cyclone. The method can also disrupt a highly coordinated relationship between the eyewall winds of the storm and the eyewall waves of the storm running parallel to a circulation of the storm to influence one or more of the storm's path or intensity. Application of the surfactants to the surface of the water body can reduce wave height and reduce the localized mean sea level to mitigate storm surge.

In some implementations, the method can include altering the track or intensity of a tropical cyclone by inducing waves that do not move in the same direction as the eyewall winds.

### FIELD

Some implementations relate generally to the field of weather modification, and more particularly, to systems and methods for modifying the intensity and/or paths of tropical cyclones, which can include hurricanes, cyclones or typhoons. Some implementations relate generally to using surfactants to accomplish these goals, and also to lessen the storm's onshore wave heights to reduce storm surge damage.

### BACKGROUND

The circular high velocity spin of a hurricane eyewall provides a highly efficient mechanism for lifting huge amounts of warm water vapor thousands of feet into the atmosphere. One important contributor to hurricane intensification is the coordinated movement of eyewall waves with eyewall winds. For example, eyewall wind speeds up to 72 mph over the continental shelf (see, e.g., Ewa Jarosz et al., Bottom-Up Determination of Air-Sea Momentum Exchange Under a Major Tropical Cyclone, Science, Vol. 315, p 1707, 23 Mar. 2007, which is incorporated herein by reference), and up to 89 mph over the ocean (see, e.g., Leo H. Holthuijsen et al., Journal of Geophysical Research, Vol. 117, C09003, which is incorporated herein by reference), cause the water surface feeding water vapor to hurricanes to offer progressively increasing wind resistance (FIG. 2). At wind. speeds above these thresholds, the water surface offers decreasing wind resistance. Upon reaching 123 mph (55 m/s) over the continental shelf, the water surface offers only slight wind resistance at this speed, thereby facilitating a faster march to higher wind speeds that fall in one of the major hurricane categories (e.g., Category IV or Category V hurricanes). Previous efforts, such as NOAA's Project STORM FURY and Project CIRRUS did not attempt any storm steerage, and instead sought to weaken hurricanes by injecting chemicals. U.S. Pat. No. 8,262,314 discloses methods of using a bluff shaped object attached to a submarine to cool the upper layers of hurricane waters by mixing them with the lower layers. U.S. Pat. Application No. 2009/0272817 discloses methods of using submarines positioned at depths below the thermocline to cool the warm ocean surface waters by releasing gases that rise to the surface. The vast bulk of previous applications and patents are not related to the disclosed subject matter in that they proposed various methods of cooling hurricane surface waters or cooling the air within a hurricane. While the task of transporting the cool waters from 300 feet below the surface would be a formidable undertaking, the high energy currents used in this application to modify wave profiles reside immediately below that surface. U.S. Pat. No. 8,256,988 discloses a large array of floating slabs used to form a partial barrier between the ocean and atmosphere, interfering with the rise of warm moist air.

One commonly-held belief is that the massive size and energy of hurricanes preclude any viable efforts to minimize their intensity and consequent damages; however this belief does not take into account the implications arising from a hurricane's spontaneous energy-depleting resynchronizations. Previous efforts to manipulate hurricanes, such as NOAA's Project Stormfury and Project Cirrus, did not attempt any storm steerage and instead sought to weaken hurricanes by injecting chemicals. Stormfury had two main possible flaws: it was neither microscopically nor statistically feasible. Evidence indicates that seeding of hurricanes may be ineffective because they contain too much natural ice and too little super cooled water. (see, e.g., Hurricanes, 2nd Ed., Patrick J Fitzpatrick, p. 251, which is incorporated herein by reference).

It may be desirable to provide a method, process, or system to modify (e.g., typically, to reduce) the intensity of hurricanes and/or tropical storms such as cyclones and typhoons, and/or to change the track or the path of hurricanes or tropical storms. Some implementations were conceived in light of the above-mentioned limitations, needs, or problems, among other things.

The background description provided herein is for the purpose of generally presenting the context of the disclosure. Work of the presently named inventors, to the extent it is described in this application, as well as aspects of the description that may not otherwise qualify as prior art at the time of filing, are neither expressly nor impliedly admitted as prior art against the present disclosure.

### BRIEF DESCRIPTION OF THE DRAWINGS

FIG. 1 is a depiction of the chimney function of a tropical cyclone's eyewall as part of the overall circulation within one sector of a tropical cyclone

FIG. 2 is a depiction of the diminishing wind drag coefficient of an eyewall water surface as wind speeds increase beyond 40 meters/second (90 mph) to 55 meters/second (123 mph) and higher.

FIG. 3 is a weather service illustration of Hurricane Matthew's 2016 centerline track along Florida's central east coast.

FIG. 4 is a local weather station's radar image of Hurricane Matthew as it was approaching the tip of Cape Canaveral in 2016.

FIG. 5 is a local weather station's radar image of Hurricane Matthew just after the hurricane's eye's center passed the tip of Cape Canaveral in 2016.

FIG. 6 is a nautical fishing chart depicting the Canaveral Shoals including the Southeast Shoal and sea floor elevations immediately east of Cape Canaveral.

FIG. 7 is a schematic drawing (simplified) depicting the vertically-stacked and powerful churning currents induced by the high wave crests within an eyewall of a tropical cyclone. These rotating currents are diverted and interfered with in accordance with some implementations.

FIG. 8 is a schematic drawing depicting a tropical cyclone's gradual change of course from a due west course to a west-northwest course initiated and maintained by typhoon class nuclear submarines maintaining a 10 o'clock position relative to the tropical storm's present 12 o'clock heading in accordance with some implementations.

FIG. 8a is a depiction of several alignments that could be adopted. The #1 rendering of FIG. 8a depicts a clockwise rotation of 6 nuclear vessels so that at least 5 vessels are interacting along the same line with the outer eyewall winds at any given time. The constant rotation should facilitate the ability of the rotating vessel as it takes up the number. 1 position to best identify the ideal positioning at the very outer eyewall edge. The #2 rendering of FIG. 8b-[also employs 5 vessels that interact along the same line but without any rotation of their positions. This approach, while requiring one less vessel, leaves open the risk that the vessel in the #1 position will be less able to maintain a position at the very outside edge of the eyewall.

FIG. 9 is a schematic drawing depicting the steep gradient in wind speeds between the outer edge of a tropical cyclone's eye and the eyewall's inner edge.

FIG. 10 is a depiction of proposed arrays of remotely-controlled fixed stations for the dispensing of environmentally neutral surfactants within the coastal waters off New Orleans (as an example) in accordance with some implementations.

### DETAILED DESCRIPTION

Hurricanes are known to temporarily lose strength when they periodically re-synchronize their shape and movements. Sustained introduction of resisting and disorganizing forces at a leading edge within the storm's outer and/or inner eyewall can diminish the storm's energy by altering the symmetrical and circular contours of the storm's eyewall and triggering energy-sapping resynchronizations. If such disrupting forces are continuously deployed, the storm can lose its capacity to intensify, suffer a decrease in strength, and even change its path or track.

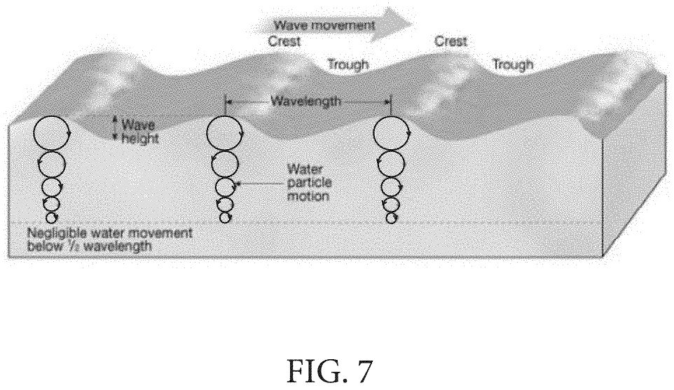

By continuously deploying a wind-deflecting resistance within a “steering helm” location (along the outer edge of the leading side of the eyewall and/or along the inner edge of the leading side of the eyewall) during a hurricane's east to west migration across the Atlantic, the path of the hurricane can be altered. Once the hurricane eyewall reaches a wind speed of 89 miles per hour, the wave structure under the hurricane begins to gradually evolve into a compatible and parallel-running partner that offers decreasing resistance to the eyewall wind. Waves induced by strong hurricane winds over a long fetch travel in the same direction as the eyewall winds and develop long spans between high crests that generate high-energy, rotating currents that are vertically stacked below the wave crests. (See FIG. 7.)

Beyond minimizing damage inflicted by high wind speeds of a hurricane's eyewall, a reduction wave height and eyewall wind speeds should also reduce storm surge damages, e.g., the storm surge of a category 5 storm is typically 10 feet higher than the storm surge of a category 2 storm. (CAT I: 4-5 feet; CAT II: 6-8 feet; CAT III: 9-12 feet; CAT IV: 13-18 feet; CAT V: greater than 18 feet) (see, e.g., http://ww2010.atmos.uiuc.edu/(Gh)/wwhlpr/hurricane saffirsimpson.rxml, which is incorporated herein by reference). Storm intensity may not necessarily affect the amount of rainfall, however. “Large, slow moving, and non-sheared tropical cyclones produce the heaviest rains. The intensity of a tropical cyclone appears to have little bearing on its potential for rainfall.” (see, e.g., Wikipedia, Tropical cyclone rainfall climatology).

A storm mitigation approach employing nuclear submarines may seek to restore short period waves with more vertical profiles as well as cross swells and opposing swells that can absorb wind energy to deflect the track/path of the storm and diminish its potential to intensify. Nuclear submarine operations within the uppermost high energy, rotating currents beneath long fetch wave crests of a tropical cyclone's eyewall can maintain and restore water surface roughness by instituting short period waves, cross swells and opposing swells. Large displacement nuclear submarines would move within the uppermost strong rotating currents (vortices); that are vertically stacked beneath the long fetch wave crests of the hurricane's eyewall (FIG. 7). That submarine presence will restructure the wave profiles both by deflecting the rotating currents back to the surface and by weakening the foundational support they provide for the very tall wave crests of the mature eyewall. When carried out across the radius of an eyewall, these operations can mitigate storm intensity by enhancing the air/water momentum exchange. When carried out at an outer edge of a leading quadrant, i.e., at the 10 o'clock on the storm's path, these operations can steer the storm's path/track to the right (in the northern hemisphere).

Nuclear aircraft carrier operations can slow the winds of the eyewall of a tropical cyclone by imposing wind absorbing and wind deflecting mechanisms on and/or above the carrier deck. When carried out across the radius of an eyewall, these operations can mitigate storm intensity by imposing wind resistance beyond that afforded by a water body's surface. When carried out at an outer edge of a leading quadrant, i.e., at the 10 o'clock position on the tropical storm's path/track, the added wind resistance induced by these operations can steer the storm's path/track to the right (in the northern hemisphere).

The surface tension of clean water enhances the wind's ability to gain a purchase on the Water surface, transfer wind momentum, and impart motion to that surface in the form of wave action. During moderate eyewall wind speeds, surface tension helps mitigate the storm intensity by assisting the development of erratic wave action. Surface tension is counter-productive beyond the 72 mph to 89 mph range, where very smooth water surfaces posing negligible wind resistance begin to form within extremely high waves. Using surface vessels or subsurface vessels, environmentally neutral surfactants can be applied to a leading eyewall quadrant in order to shepherd the path or track of the tropical storm. When applied off-shore from near coastal locations, such environmentally neutral surfactants can, for example, be deployed from an array of fixed stations to mitigate storm surge.

Nuclear-powered submarines can be deployed at an appropriate location corresponding to a storm's eyewall to duplicate the effect of a continuous shoal in order to continuously steer and deflect the path of a tropical storm. This deflection can cause the tropical storm to resynchronize and expend energy in the process of regaining lost symmetry. The inclination of a tropical cyclone to maintain its synchrony is similar to the moon maintaining synchrony with the earth by turning on its own axis at a rate identical to the rate at which the moon orbits the earth. The circular shape of a tropical storm's eye and eyewall and the near perfect coordination of the eyewall winds with the waves below are essential to the tropical cyclone's efficient operation and its ability to more quickly intensify into a Category 3, Category 4 or Category 5 storm (i.e., the major storms).

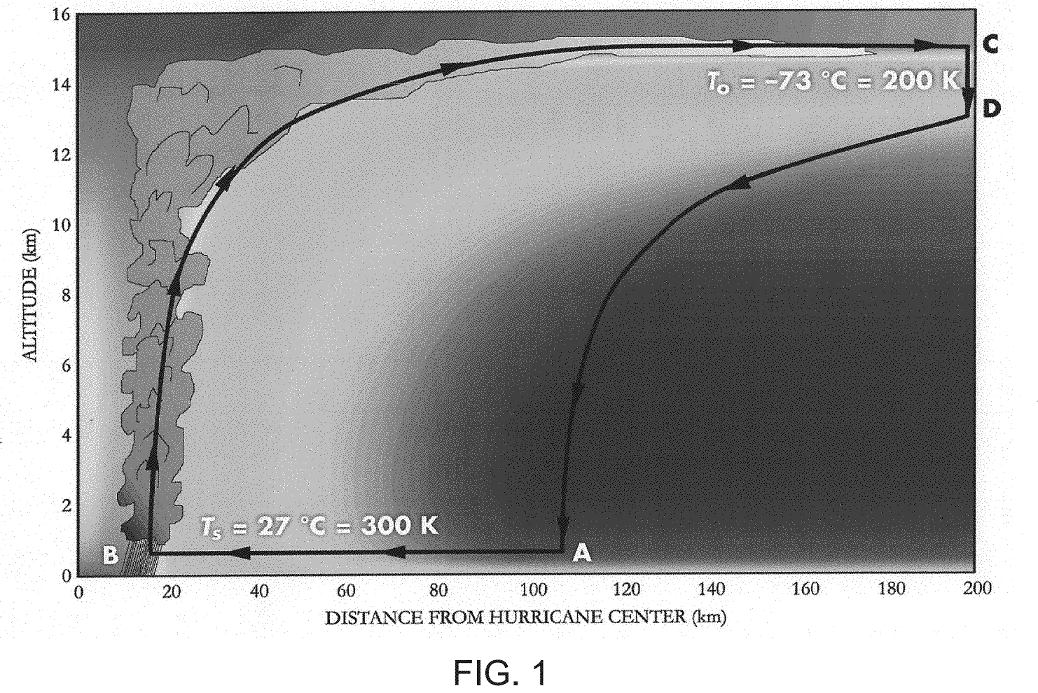

The eyewall serves as the site of concentration of the tropical storm's strongest winds and as a high velocity chimney that propels evaporated seawater gathered from the eyewall and from across the outer storm field up to an altitude of 14 kilometers (8.7 miles). FIG. 1 is a depiction of a tropical storm eyewall's chimney function. An important third feature of the eyewall is the strong angular momentum of its long fetch waves that travel through the water medium. Once winds within the eyewall of a tropical storm reach 89 mph, eye wall waves that have been exposed to essentially uniform, unidirectional winds for many miles start to lose their hyperactive and disorganized “short period” character. The water surface between waves then starts losing its roughness and the surface begins [delete “s”] to transform into waves with long distances between crests that offer decreasingly less resistance to the winds.

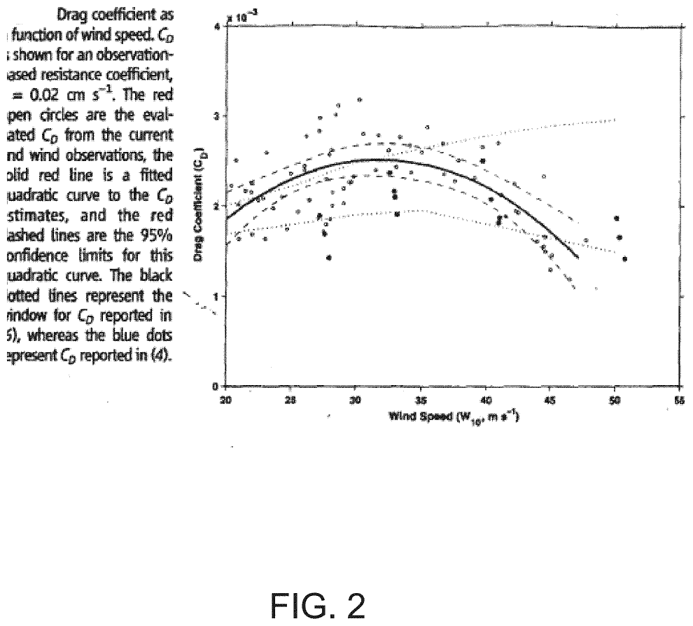

Although wind resistance gradually increases with increasing wind speeds up to the 72-mph level, the brakes start to wear off at that point as the drag coefficient begins to decrease in the face of increasing wind speeds. FIG. 2 is a depiction of wind drag coefficient of an eyewall water surface as wind speeds increase to 55 meters/second (123 mph). A significant compatibility develops at the 123-mph stage as long and powerful waves are now moving in the same direction with the wind and present a more cooperative surface which no longer offers significant wind resistance. (see, e.g., Jarosz et al., Bottom-Up Determination of Air-Sea Momentum Exchange Under a Major Tropical Cyclone, Science, Vol. 315, p. 1707, 23 March 2007, which is incorporated herein by reference). At this point, the eyewall of the storm can more quickly advance to higher category wind speeds.

One of the disclosed methods for slowing increase in tropical storm intensity is therefore aimed at forestalling and reversing the development and growth of high waves having long wave lengths that move in a parallel direction with the wind. The disclosed methods for shepherding the path of a tropical storm can entail imposition of enhanced wind resistance at the outer edge of a leading eyewall sector, thereby triggering a realignment of eyewall contours and imposing a new sense of direction for the storm. Extremely high eyewall waves, the product of a long fetch in strong tropical cyclones, can generate strong subsea, rotational currents that are vertically stacked, reaching down as far as 300 feet, and that continue to churn for days (see, e.g., Brian McNoldy, HUFFPOST, Dec. 6, 2017, which is incorporated herein by reference). The height of the water from the top of a long fetch hurricane wave crest, e.g., 30 feet above mean sea level and 60 feet above the wave trough bottom, generates revolving currents or eddies below. Despite outward appearances of immutability, the long fetch waves of a tropical storm's eyewall have no momentum but instead possess only a retractable pseudo-momentum.

In one embodiment, nuclear submarines can be used to deflect high energy, churning currents back up to the surface, thereby duplicating the effect of an ever-present shoal. This migrating “faux shoal” can produce cross swells and opposing swells as well as shorter period waves having a vertical profile. These effects impose substantial wind resistance in place of long fetch waves that offer only negligible wind resistance. While the gradually rising ocean floor along a shoreline gradually imposes its energy depleting influence on oncoming waves, the continuously induced deflection by submarines can trigger a more dramatic reaction at the surface, similar to a prominent/continuous shoal. When enhanced wind resistance is persistently imposed at a leading sector of an outer eyewall of a tropical cyclone, the eyewall's wind stream follows the path of least resistance, resulting in a localized flattening of the eyewall's circular geometry at that location and eventually a new locational identity for the eye once the eyewall has resynchronized itself into a circular form. A persisting wind resistance selectively imposed at a leading sector of the outer eyewall can shift the storm's path/track as the wind corridor continues to move away from the resistance.

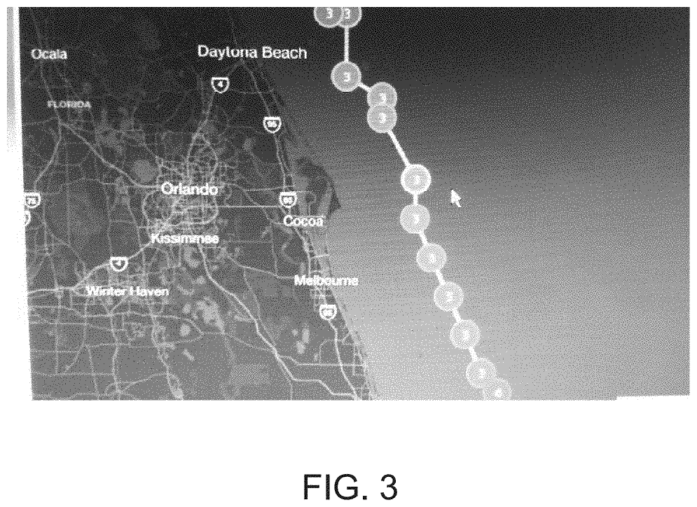

FIG. 3 is a weather service illustration of Hurricane Matthew's centerline track along Florida's central east coast. In 2016, the eye of Matthew zig-zagged around the Cocoa/Cape Canaveral/Kennedy Space Center/Merritt Islnd shoreline as Matthew tracked north, parallel to Florida's eastern shore. The outer portion of the leading quadrant of Matthew's eyewall there encountered course-deflecting wind resistance largely from enhanced wave turbulence induced by the Canaveral Shoals and the rising ocean floor just off the Cape. Once Matthew's eyewall edged past the tip of Cape Canaveral, the 10 o'clock sector of its leading edge was no longer influenced by the Cape's rising sea floor and, more significantly, was no longer influenced by the southeast shoal. The storm then shifted from a northeasterly course to a northwesterly course, again resuming a course parallel to Florida's eastern shore. This is evidence that enhanced wind resistance generated by a sudden elevation in the sea floor can shift a storm's direction when an eye wall approaches a landmass at an obtuse angle. This brief course shift caused by the Canaveral Shoals is expected to be an extended course shift in the face of the extended application of the several embodiments of this application.

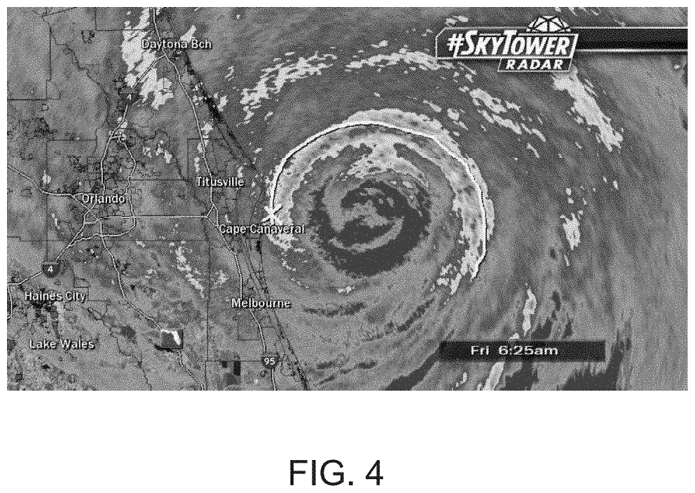

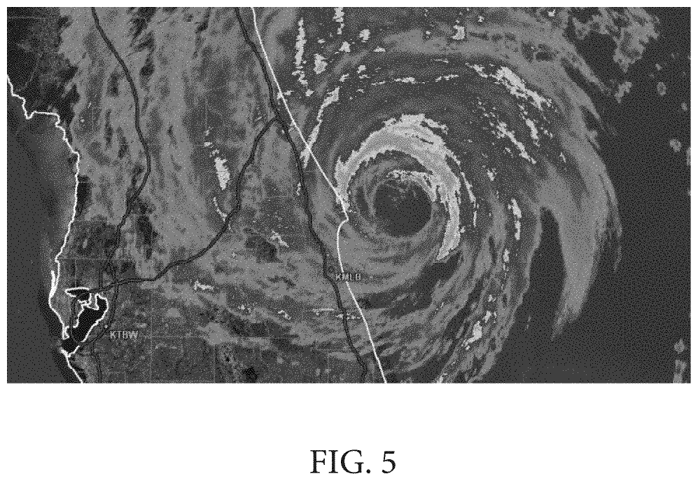

FIG. 4 is a local weather station's radar image of Hurricane Matthew as it approached the lip of Cape Canaveral in 2016 and FIG. 5 is a local weather station's radar image of Hurricane Matthew just after the hurricane's eye's center passed north of the tip of Cape Canaveral. On its approach to the tip (FIG. 4), the eye is slightly egg-shaped and oriented north-east to south-west, parallel to the southern coastline of the Cape. The 10 o'clock sector of the eye appears to be compressed by the Cape's southern coastline as it moves parallel to the coastline. Just after the eye's center passed the Cape's tip, the eye begins to evolve into a different egg shape with a north-west to south-east alignment, consistent both with the coastline immediately north of the Cape's tip and consistent with a new track the storm was about to take up (FIG. 5). Not only did the tropical storm twice change its track, its eye went through significant realignment just as it was changing course. These changes point to a sensitivity in the eye and the eyewall that are directly related to the ensuing new path to be followed by the storm.

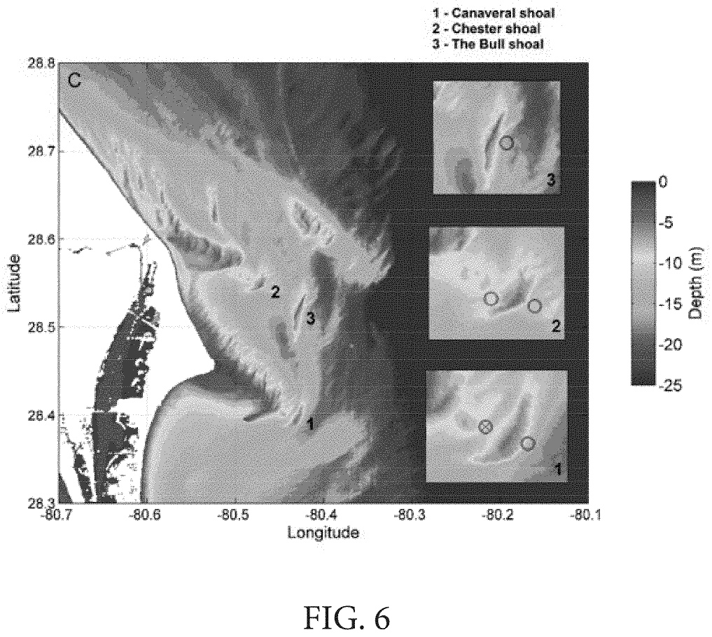

FIG. 6 is a nautical fishing chart depicting the Canaveral Shoals, including the Southeast Shoal and sea floor elevations immediately east of the tip of Cape Canaveral. The Southeast Shoal lies immediately east of Cape Canaveral and presents a markedly rising sea floor shaped in the form of a narrowing finger. Only a relatively small fraction of Matthew's eyewall encountered the sparse landscape on Cape Canaveral in that it was only the eyewall's western edge that barely clipped NASA's Cape Canaveral launch facilities. The vast bulk of Matthew's eyewall at its 10 o'clock sector interacted only with the ocean's hyperactive surface. It is therefore very likely that the erratic wave action over the rising ocean floor along the eyewall's leading/outer edge was the reason for Matthews's 2016 side-step dance around the Cape. Enhanced transfer of the wind's energy to waves above a shoal or rising sea floor means lost energy for the storm. The loss is partly attributable to the significantly larger surface area of shorter period waves within a given distance. A significantly larger wave surface area having a more vertical profile results in an increased drag on wind speed. A marked increase in wind drag at the outer floor of the eye wall will change the eye-wall configuration as the wind stream diverts away from the obstruction. That increase in wind drag, however, is for the most part attributable to the conversion of long period waves (that move in the same direction as the eyewall winds) into erratic short period waves at the sensitive 10 o'clock quadrant. Hurricane Matthew reset its path or track upon reorganizing and regaining its circular and more efficient form.

FIG. 7 is a simplified diagram depicting parts of an ocean wave within an eyewall of a tropical cyclone. At the surface of the ocean, there are crests and troughs. The crests of a wave are separated by a wavelength and the depth to which a wave's effects can be felt depends on the wavelength and the wave height. (see, e.g., What Happens Underwater During a Hurricane? Brian McNoldy, U of Miami's Rosenstiel School of Marine & Atmospheric Science, HUFFPOST, Dec. 6, 2017, which is incorporated herein by reference). A tropical cyclone's eyewall winds over the deep ocean ultimately produce waves running parallel to the circulation of these winds. Waves with long troughs can act in coordination with the winds above such that they offer virtually no wind resistance. “At surface wind speeds of 40 m/s (89 mph) . . . , the roughness begins to decrease, and a high-velocity surface jet begins to develop. The roughness reduces to virtually zero by 80 m/s (179 mph) wind speed, rendering the surface aero-dynamically extremely smooth in the most intense part of extreme (or major) hurricanes (wind speed >50 m/s) (112 mph).” (Winds and waves in extreme hurricanes, Holthuijsen, Abstract, Journal of Geophysical Research, Vol. 117, issue C9, C09003, which is incorporated herein by reference).

In an alternate embodiment aimed at weakening the tropical cyclone and precluding further intensification, two or more nuclear submarines or nuclear aircraft carriers can start at a location other than a leading sector and simultaneously crisscross on diagonal courses between the outer eyewall and the inner eyewall. In a still further alternative embodiment, nuclear submarines or nuclear aircraft carriers can maintain the same continuous positions other than at the leading sectors of the storm so as to distort eyewall circular geometry and minimize the development of hyper wind speeds within the eyewall without significantly altering the storm's path/track.

Some embodiments can harness the power of the eyewall's own strong undercurrents to weaken and redirect the storm's course while other embodiments can employ nuclear aircraft carriers to achieve these same results by more directly slowing or deflecting the winds at the edge of the eyewall. One significant part of the disclosed mitigation methods lies in the identification of the vulnerabilities of these powerful storms.

Another embodiment applies surfactants to the ocean surface in order to alter the tropical storm track or path, alter storm intensity by reducing wave height and increasing wind resistance, and mitigate tropical storm surge along a coastline by using surfactant-dispensing array stations. The disclosed methods leverage the coincidence of two extremes, i.e., persisting wind speeds exceeding 112 mph that pass over a surface of a water body that offers negligible wind resistance. When powerful rotating currents of a water body encounter a sudden rise in the basin floor along a coastline, or when the disclosed methods are able to artificially duplicate such phenomenon, the high energy of these currents can be redirected back to the water body surface, altering the long wave lengths and wave heights of long fetch waves. Once long wave lengths are converted into shorter period waves, many miles of exposure to winds of the eyewall may be required before long wave lengths can be restored (a long fetch). That carry-over effect, together with the precise application of continuing added resistance at the eyewall edge, can cause the eyewall wind corridor along its leading outside edge to divert away from the persisting obstruction. A shifting of the wind stream corridor can lead to a deflection in the path/track of the storm as the law of conservation of energy and other natural forces work to resynchronize the tropical storm's movements and restore its lost circular symmetry. An ongoing process of induced resynchronizations can prevent the progression of a tropical storm into a major hurricane with wind speeds of category III hurricanes and above.

When the wind field becomes weak, an externally applied disorganizing and steering influence may have the least difficulty in maintaining pace while deploying the maximum amount of wind brakes. The average forward speed of tropical storms and hurricanes in the tropical latitudes is of the order of 12 mph. Any difficulty in keeping pace with a storm that is moving quickly across the ocean may require a submarine storm escort fleet to temporarily take refuge more than 300 feet below the surface—free from the strong circular currents induced by the storm above—or within the eye of the hurricane. Besides the ability of a submarine to safely maneuver within such turbulent waters, equally essential may be its ability to keep pace with the storm and maintain a position precisely within the storm's sensitive steering helm for as long as needed.

This shepherding method can take advantage of rebound mechanics. Not unlike the course-changing effect on a rolling basketball whose leading edge temporarily deforms upon impacting a raised curb at a slight (obtuse) angle, the tropical storm can experience an ongoing series of course corrections when a leading sector of its outer eyewall deforms upon encountering persistent resistance. The storm's course correction arises out of the evasive action taken by its eyewall, partly because of the law of conservation of angular momentum and partly because of the Coriolis effect, which uniformly bends to the right all incoming air approaching a low-pressure system within the northern hemisphere. A tropical cyclone's steering helm can be vulnerable to human management because the steering helm's location is focused within the much narrower high-energy eyewall, and more specifically at 10 o'clock on the eyewall's outer edge. The goal of steering is to shift the course of the tropical storm within the northern hemisphere to the right and in the direction of the north Atlantic by causing the wind stream to divert toward the center of circulation and develop a flattening of the eyewall at the 10 o'clock sector. For the eyewall to morph back into a more perfect circle, the eyewall and its conjoined eye must shift to the right, thus leading to a course correction. The persistent interjection of a deflecting wind break at that pivotal point on the tropical storm's compass may cause an ongoing resynchronization of eyewall geometry and alter the ensuing direction taken by the storm. Placement of a submarine storm fleet at the 10 o'clock position can enable the fleet to maintain pace with the tropical storm in that the vessels will be aligned on essentially the same course as is being followed by the storm, while also remaining in the best position to deflect the strong, underlying currents up to the surface of the water body.

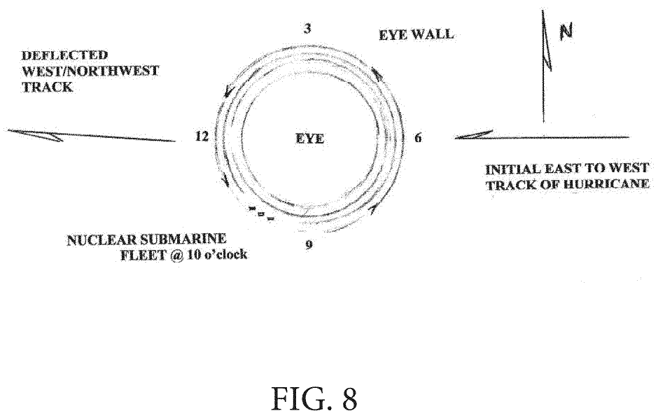

FIG. 8 is a schematic drawing depicting a tropical cyclone's gradual change of course from a due west course to a west-northwest course initiated and maintained by typhoon class submarines that maintain a 10 o'clock position relative to the storm's present 12 o'clock heading in some implementations. 12 o'clock here is defined to be the present direction of the storm's path/track. In some implementations, submarine operations at 2 o'clock on the inside edge of the eyewall may also deflect the track/path of a tropical storm to the right with the submarines moving in the same direction as that of the eyewall winds. As the submarines operate within the revolving currents and not within the waves, the interaction between the submarine's displacement and the strong revolving undercurrents can deflect the storm's path/track. The inner eyewall location adjacent to the eye is where the eyewall's fastest winds may be found. The boundary between the outer eye and the inner eyewall is also where highest wind speed gradient exists, thereby making this boundary more readily identifiable than the boundary at the edge of the outer eyewall.

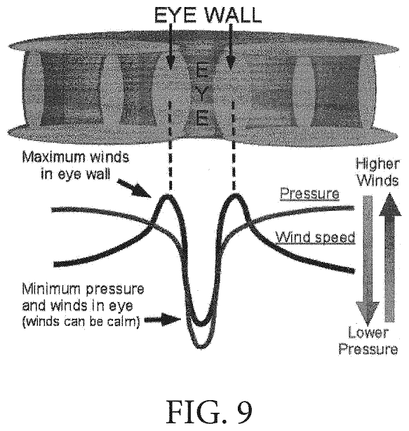

FIG. 9 is a schematic drawing depicting the steep gradient in wind speeds between the outer edge of the eye and the inner edge of the eyewall. In some implementations, two to six large displacement submarines equivalent to a Russian Typhoon class, operating at a predetermined position within the outer eyewall of a tropical cyclone can provide the required amount of force to disorganize, reshape, and redirect the storm. The same numbers may suffice for an alternate application designed solely for the purpose of mitigating storm intensity. In some implementations, Typhoon class submarines will run in a closely staggered formation with the leading submarines to the outside of the following submarines, each operating at the most effective distance below the sea surface through the stacked and churning currents (see, e.g., FIG. 8). The length of an equivalent Typhoon class submarine can deflect high energy currents beneath more than one wave crest at the same time as its length exceeds a typical long fetch wavelength.

Submarines may experience forces from many directions while moving through currents beneath one or more wave crests. Computer-controlled stabilizing and propulsion jets may be necessary to control a submarine's yaw, pitch; roll and speed. A suitable number of sturdy sensors providing real time data about the forces affecting the vessel may also be required. Nuclear-powered submarines can match the relatively slow ground speed of a developing tropical cyclone. To match the storm's faster ground speeds while buffeting the strong opposing undercurrents may require a streamlined profile rather than a profile with appendages. Therefore, submarines having sufficient beam and displacement may not require any current-disrupting appendages along the surface of the vessels. Submarines that seek to mimic a suddenly rising sea floor may have to operate at shallow depths, where the strongest of the currents induced by long fetch waves are to be expected. A comprehensive array of stabilizing controls and sensors may fail to provide an endurable ride within these submarines, so that these submarines may need to be remotely controlled. Control submarines can operate beyond the strong storm-generated currents that extend 300 feet beneath the storm winds—either below these strong currents or inside the calm of the adjacent eyewall, as in the case of operations at 2 o'clock on the inside edge of the eyewall.

Nuclear submarines operating within powerful rotating currents will create new cross-swells and opposing-swells, which in turn can reinforce existing swells and delay/prevent the development of long fetch waves. Cross swells and opposing swells serve as a major counter force to the development of long wave lengths. Many hours of sustained high winds blowing in the same direction will be required to again transform short period waves into waves having long wave lengths. Intervention by nuclear submarines can increase cross swells and opposing swells in number and/or intensity to alter the wave structure and help reduce the pace of intensification of the storm and/or force the storm to resynchronize to an earlier stage of the storm's development.

The above described submarine embodiments can reduce a tropical storm's eyewall wind speeds by upwardly deflecting high-energy rotating currents beneath the wave crests at an outer leading sector. This can lead to waves along that leading sector to be restored to a wind-resisting short period profile, which will in turn deform the circular symmetry of the eyewall, alter the direction taken by the tropical storm, induce an ongoing state of resynchronization, and impair the storm's transition to hyper speeds corresponding to those of category 4 or category 5 storms.

In some implementations, a fleet of nuclear-powered aircraft carriers with wind-slowing vertical axis wind turbines (“VAWT”) mounted on telescoping pedestals or on a series of ridges aligned from port to starboard and building in height from the bow to the stern appropriately on the deck can be deployed. Given the high wind speeds to be encountered, each VAWT can be equipped with wind-slowing blades similar to blades of a jet engine's intake fan. Unlike wind turbines turning on a horizontal axis, wind turbines turning on a vertical axis thrive on high wind speeds and have little to no difficulty with sudden variations in wind direction. This characteristic also allows for the placement of multiple rows of VAWTs despite downstream turbulence from the leading units. The goal is to absorb energy from the eyewall winds of a tropical storm using VAWTs mounted on vessels and therefore slow the eyewall winds at the outer edge of the eyewall's 10 o'clock sector.

Configurations that can shunt the backwash to the side towards the interior of the eyewall may both help the fleet maintain its position at the very edge of the eyewall and augment efforts to degrade eyewall symmetry. Alternate embodiments employing a series of hard surface vertical walls angled to deflect the wind stream to the desired side of the ship can result in a deflection in the wind's direction and to a lesser extent result in an absorption and slowing of the wind. The relative positions of multiple ships to each other at the eyewall's outer edge may be critical in order to achieve true compression of the outer eyewall and avoid non-productive splitting of the eyewall wind corridor. Rotating turbine blades mounted on vertical columns that extend as much as 30 feet in height above a carrier deck and that reach 90 feet above the water surface may have a greater wind dampening effect than friction forces imposed at the water surface. A greater wind-absorbing and wind-deflecting proficiency of a nuclear aircraft carrier may translate into fewer aircraft carriers required to achieve the same course-deflecting effect. While there may not be any need to generate further power on a nuclear carrier, the harnessing of these wind turbines to create additional electrical power will enhance their ability to carry out their primary mission of dissipating eyewall wind energy and velocity. This auxiliary power supply would free up most of the generated nuclear power for propulsion and other operational energy needs of the carrier. The primary function of the vertical axis wind turbines will be to slow the winds of the outer eyewall corridor and trigger the desired deflection in the storm's path. Their secondary function will be to absorb and transfer wind energy into mechanical energy. The aircraft carriers will operate directly into the waves of a tropical cyclone's eyewall where the waves have long spans between wave crests. The carriers will maintain a position at 10 o'clock while following the present course being taken by the storm.

In another embodiment, the same deflection in the storm's track/path to the right may be achievable by aircraft carrier fleet operations at 2 o'clock on the edge of the inner eyewall. In this configuration the aircraft carriers would be moving in the same direction as both the high-speed winds and the waves. A vertical axis turbine design for 2 o'clock operations will require larger fins, or fins that further project outward from the turbine shell, or fins that otherwise result in an enhanced purchase on the eyewall winds. Such modifications would help compensate for the net lower incoming wind speed at 2 o'clock. The edge of the inner eyewall immediately adjacent to the storm's eye may be the location of the highest eye wall speeds and where highest wind speed gradient exists within a storm. This high gradient may render the inner eyewall boundary more readily identifiable than at the eyewall's outer edge and enhance the aircraft carriers' ability to maintain a precise position on the eyewall edge (see FIG. 9).

Operations at 2 o'clock on the edge of the inner eyewall may also provide a readily accessible, albeit a temporary, safe haven within the storm's eye. The eye of the storm may also provide a comfortable staging location before storm track/path shepherding begins and during intermittent interruptions while the storm maintains a desired heading. The resynchronizations of tropical storms temporarily weaken storm intensity. The constituent parts of a storm's eyewall are intimately interconnected and this requires all of its sectors to march to the same beat, i.e., with the same angular momentum around the eye. Any significant disruption in eyewall speed, eyewall wave height, or eyewall corridor symmetry in one sector therefore requires a resynchronization throughout the full circle of the eyewall, and that takes time and saps some of the storm's energy.

The deployment of surfactants within open water bodies from either aircraft carriers or nuclear submarines or fixed stations offshore in coastal locations is another embodiment of this disclosure. The surface tension of clean water, unmodified by surfactant films, enhances the wind's ability to gain a hold on the water surface and impart motion to that surface by transferring momentum and generating wave action. The longer the interaction, enhanced by surface tension, the higher are the waves and the longer are the resulting wave lengths. Surfactants, can, however, significantly lessen surface tension; and that reduction in surface tension can lower wave height considerably. By preventing waves from gaining height, surfactants can cause the water surface to maintain its wind-slowing roughness. Although the winds may still develop speed, they may advance to higher speeds more slowly. Surfactants can decrease wave height in the sense that high waves with long wave lengths can be prevented, reduced, or slowed from forming.

Water's surface tension, i.e., adhesion between adjacent water molecules on a water surface, is one factor that contributes to the ability of a water surface to slow winds as they attempt to pass by. The large surface area of numerous and closely spaced short period waves with their more vertical walls in moderate storm winds also adds to the rate of the air/water momentum exchange. In the face of moderate eyewall wind speeds, surface tension helps mitigate storm intensity by enhancing the air/water momentum exchange with wind-slowing, erratic wave action. An early application of surfactants within the outer edge of a developing eyewall's leading quadrant can assist in altering the storm's path/track by preventing its progression to higher waves having long wave lengths and diminished wind resistance. This can alter contours of the eyewall corridor as the wind stream follows the path of least resistance, triggering resynchronizations and deflecting the track/path of the tropical storm to the right as long as the required surfactant concentration is maintained. Surfactants may have to be initially released at a high rate, but later reduced to that needed to keep up with losses due to mixing and chemical decomposition. The rate of surfactant dilution and within the long fetch waves of a mature tropical cyclone should be less than that within short period waves.

Dissolved surfactants coating the surface of hyperactive short period waves may quickly dissipate even with a slowing effect from encapsulation techniques, so that repeated or continuing application of surfactants may be required. The position of the eyewall's sensitive steering helm will be continually migrating in concert with the storm's forward progress and its evolving track/path. The surfactants used should be durable as well as environmentally neutral. A series of such interventions using surfactants in the face of moderate wind speeds can alter the storm's developmental timetable so as to considerably impact not only a storm's track/path bit also its intensity. Deployment of surfactants just outside the leading quadrant of the eyewall and within waters characterized by short period waves can deny even a mature storm its capacity to venture onto a more westerly course than the one the storm is on.

When deployed from an array of fixed stations offshore in coastal locations, surfactants can also help mitigate storm damages by lessening storm surge. In addition to lowering wave height, surfactants can reduce the wind's ability to exert the same strong “direct push” on the back of waves now having a lower profile, thereby lessening the localized mean sea level and the incoming wall of water. There are accordingly two “storm surge” reasons for deploying surfactants within the offshore waters of coastal location's. Surfactants are significantly more effective when employed within near-shore waters than over the ocean as proposed in paragraph 0078 above (J. of Geophysical Research, Vol. 108, No. C4, 3127).

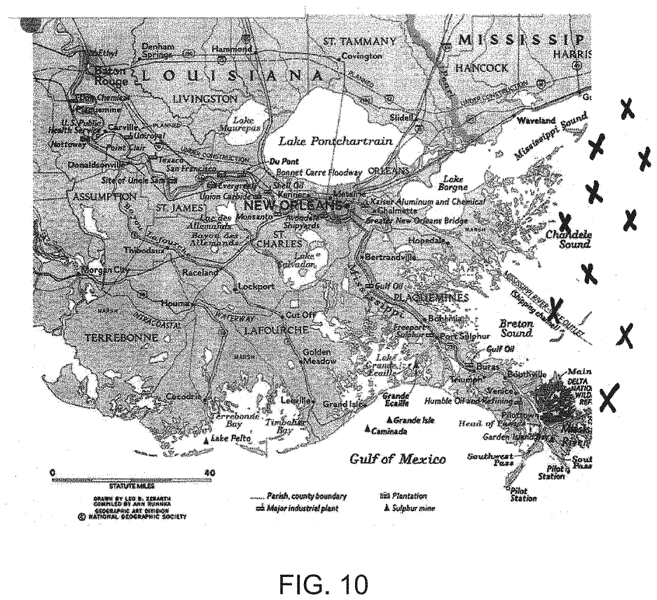

One or more inner arrays of surfactant stations may be required in addition to the outermost arrays. FIG. 10 shows arrays of fixed stations with remotely controlled surfactant-dispensing capabilities within the coastal waters off New Orleans in that implementation.

Each fixed station may include its own storage reservoir so that damage or malfunction with one station or within a distribution system between stations does not adversely affect the operation of other stations. Each station can be independently and remotely controlled from shore. Although the precise landfall of a hurricane cannot be predicted well in advance, highly vulnerable coastal locations that would suffer heavy damage by an oncoming storm surge are already well known, i.e., New Orleans. Surfactant stations offshore from these vulnerable coastal locations can therefore be planned and constructed well in advance.

Vertical axis wind turbines, ideally acting in combination with the deployment of surfactants from the same fixed stations, should serve to further dampen storm surge by slowing, redirecting and disorganizing the otherwise straight line push of a hurricane's onshore winds at the water surface.

It will be appreciated that the methods described herein are for illustration purposes only and are not intended to be limiting. Other methods may be used depending on a contemplated implementation. It will be appreciated that the submarines, aircraft carriers, surfactants and surfactant-dispensing arrays described herein are for illustration purposes only and are not intended to be limiting. Other types of submarines, aircraft carriers, surfactants and surfactant-dispensing arrays may be used depending on a contemplated implementation. An example process/method for reducing intensity of the tropical storm can include deploying nuclear submarines in a water body below an outer eyewall of the tropical storm to reduce a capacity of the tropical storm to intensify by one or more of: mimicking a rising floor of the water body, distorting circular symmetry of the outer eyewall of the tropical storm and triggering periodic resynchrcnizations, inducing short period wave action within the outer eyewall of the tropical storm to increase wind resistance by deflecting revolving currents back up to a surface of the water body, equipping the nuclear submarines with one or more of water jet systems or air jet systems to deflect rotating currents back up to the surface of the water body, deploying nuclear aircraft carriers on an outer edge of an eyewall of the tropical cyclone at a leading quadrant of the storm in order to impose wind resistance, or using eyewall management techniques designed to prevent development of the storm exceeding wind speeds of 100 mph by one of maintaining or restoring wind-resisting short period waves and preventing non-wind-resisting long period waves. The tropical cyclone or storm can be a hurricane, a typhoon, or a tropical storm.

In some implementations, one step can include causing enhanced wind resistance induced by erratic wave action at the 10 o'clock sector of the outer eyewall of the tropical storm to trigger an inward flattening of the eyewall of the tropical storm and divert a forward path of the tropical storm in a rightward direction from an initial path of the tropical storm in Earth's northern hemisphere. Another step can include causing a sustained diversion of wind stream of the outer eyewall of the storm to reposition a center of an eye of the storm in the rightward direction and deflect a path of the storm to the rightward direction in the Earth's northern hemisphere.

In some implementations, one step can include causing enhanced wind resistance induced by erratic wave action at 2 o'clock sector of an inner eyewall of the tropical storm to trigger an inward flattening of the eyewall of the tropical storm and divert a forward path of the tropical storm in a leftward direction from an initial path of the tropical storm in Earth's northern hemisphere. Another step can include causing a sustained diversion of wind stream of the inner eyewall of the tropical storm to reposition a center of an eye of the tropical storm in the leftward direction and deflect a path of the tropical storm to the leftward direction in the Earth's northern hemisphere. In some implementations, one step can include inducing, using the nuclear submarines, erratic short period wave action within the outer eyewall of the storm to increase wind resistance in the corresponding portion of the outer eyewall of the storm; reducing the capacity of the storm to intensify by distorting the circular symmetry of the outer eyewall of the tropical cyclone; and causing simultaneously and in a balanced manner enhanced wind resistance via deployment of the nuclear submarines on diagonal paths crisscrossing beneath the outer eyewall of the storm to reduce wind speeds and mitigate intensity of the storm without influencing its path.

In some implementations, one step can include inducing, using the nuclear submarines, erratic short period wave action within the outer eyewall of the storm to increase wind resistance in corresponding portion of the outer eyewall of the storm; reducing the capacity of the storm to intensify by distorting the circular symmetry of the outer eyewall of the storm; and causing simultaneously and in a balanced manner enhanced wind resistance within the outer eyewall of the storm, e.g. at 11 o'clock and at 1 o'clock via deployment of the nuclear submarines at those leading sectors of a path of the storm to reduce wind speeds and mitigate the intensity of the storm without influencing the path of the storm.

In some implementations, one step can include operating the nuclear submarines at an inner portion of the eyewall of the tropical storm at 2 o'clock to produce an inward flattening of the inner portion of the eyewall of the tropical storm at 2 o'clock and deflecting a path of the tropical storm to a rightward direction. In some other implementations, one step can include operating the nuclear aircraft carriers at an inner portion of the eyewall of the tropical storm at 2 o'clock to produce an inward flattening of the inner portion of the eyewall of the tropical storm at 2 o'clock and deflecting the path of the tropical storm in a rightward direction.

In some implementations, one step can include causing enhanced wind resistance by wind turbines mounted on the decks of nuclear aircraft carriers. These VATs rotate on their vertical axis to trigger both a slowing and a deflection of an outer eyewall wind corridor resulting in an inward flattening of the tropical cyclone eyewall and a diversion of a path of the storm in a rightward direction from initial path of the storm in Earth's northern hemisphere. The method can also include causing a sustained diversion of wind stream of the outer eyewall of the storm to reposition a center of an eye of the storm in the rightward direction and deflect the path of the storm to the rightward direction in the Earth's northern hemisphere.

In some implementations, one step can include causing enhanced wind resistance at 2 o'clock sector of an outer eyewall of the tropical cyclone to trigger an inward flattening of the eyewall of the tropical storm and divert a forward path of the storm in a leftward direction from an initial path of the tropical storm in Earth's northern hemisphere. The method can also include causing a sustained diversion of the wind stream of the eyewall of the storm to reposition a center of an eye of the storm in the leftward direction and deflect a path of the tropical storm to the leftward direction in the Earth's northern hemisphere.

In some implementations, one step can include increasing wind resistance at the outer edge of the eyewall of the tropical storm using wind-absorbent and wind-slowing wind turbines installed on the nuclear aircraft carriers, wherein the wind-absorbent and the wind-slowing wind turbines turn on a vertical axis mounted on vertical columns and wind-deflecting structures. Another step can include introducing simultaneously in a balanced manner wind resistance within the outer eyewall of the tropical storm via deployment of the nuclear aircraft carriers on diagonal paths crisscrossing within the eyewall of the tropical storm to reduce wind speeds and mitigate storm intensity without influencing a path of the tropical storm. In some implementations, yet another step can include introducing simultaneously in a balanced manner wind resistance within the outer eyewall of the tropical cyclone via deployment of the nuclear aircraft carriers at locations other than a leading sector on a current path of the tropical storm to reduce wind speeds and mitigate storm intensity without influencing a path of the tropical storm.

In some implementations, a method for modifying a path of a tropical cyclone can include manipulating its path across a water body by one of deforming a circular shape of the eyewall or imposing wind-resisting forces at an outer eyewall of one or more leading sectors of the storm in a direction of the path of the storm. The tropical cyclone or a storm can be one or more of a hurricane, a typhoon, or a cyclone.

In some implementations, a method for one or more of modifying a path of a tropical cyclone or reducing intensity of the tropical cyclone can include applying surfactants to a surface of a water body beneath the storm or introducing disruptive influences by deploying nuclear submarines below an outer eyewall of the storm such that the nuclear submarines run abreast/inline on a parallel course beneath one of adjoining or nearby separated storm wave crests. The tropical cyclone or storm can be one or more of a hurricane, a typhoon, or a cyclone. The method can also disrupt a highly coordinated relationship between winds of the tropical cyclone and waves of the storm running parallel to a circulation of the storm to influence one or more of the storm's path or intensity. Application of the surfactants to the surface of the water body can reduce wave height and increase wind resistance to mitigate storm surge. In some implementations, the method can include nuclear submarines or aircraft carriers maintaining a course at a moderate angle of deflection towards an eye of the tropical storm so as to induce a direction of eyewall waves that is against or at least not in concert with the current direction of the winds of the eyewall of the storm.

The disclosed methods can help reduce tropical cyclone intensity, retard the pace of storm intensification, reduce tropical cyclone surge along coastal areas, and help steer tropical storms into a course that can potentially impart much less damage to the mainland and populated areas. It will be appreciated that any dimensions or numbers of ships described herein are for illustration purposes only and are not intended to be limiting. Other dimensions or numbers of ships could be used depending on a contemplated implementation.

Some implementations can include a method for limiting the further intensification of a tropical cyclone or hurricane, or for reducing its already-achieved intensity, the method comprising: using nuclear submarines, or nuclear aircraft carriers, or surfactants, or a combination thereof in order to selectively slow eyewall wind speeds within an outer or inner eyewall edge, thereby imposing a continuing state of eyewall deformation, and loss of synchrony that triggers ongoing energy-sapping resynchronizations.

Some implementations can include a method for limiting the further intensification of a tropical cyclone or hurricane, or for reducing its already-achieved intensity, the method comprising: using nuclear submarines, aircraft carriers or surfactants, or a combination thereof to realign and distort the long fetch waves within the outer eyewall moving in a parallel direction with the wind and offering negligible wind resistance, and convert them to short period waves moving in many directions and offering substantial wind resistance.

Some implementations can include a method for influencing the direction taken by a storm or hurricane, the method comprising: deploying nuclear submarines, or nuclear aircraft carriers, or surfactants or a combination thereof by selectively slowing eyewall wind speeds at a leading quadrant within an outer or inner eyewall edge, e.g. at 10 o'clock on its present track, so as to cause a continuous series of eyewall deformations, a continuing flattening of the eyewall at its 10 o'clock sector, a continuing series of eyewall realignments, and a continuing series of adjustments in the location of the eye of the storm to the right.

In some implementations, the method can further comprise: the deployment of nuclear submarines, operating at shallow depths below the surface so as to intercept and redirect the strong revolving currents beneath wave crests back up to the surface, thus re-establishing short period wave profiles and increasing wind resistance within the outer eyewall at a leading quadrant.

In some implementations, the method can further comprise the deployment of nuclear aircraft carriers equipped with multiple arrays of vertical axis wind turbines or other wind-absorbing, or wind deflecting mechanisms or windbreaks that cause the outer eyewall wind stream to divert inwardly and away from such wind obstructions at a leading eyewall quadrant.

In some implementations, the method can further comprise the dispersal of surfactants upon the water surface in order to lower the height of long fetch waves, restore short period wave profiles, and reduce outer eyewall wind speeds at a leading quadrant.

Some implementations can include a method for modifying a hurricane's coastal storm surge, the method can comprise: reducing the height of hurricane onshore waves, reducing the localized mean sea level, and reducing the height of hurricane onshore water surge by the deployment of environmentally acceptable surfactants from fixed stations that have been established well in advance at strategic locations offshore of the most storm-surge vulnerable portions of a coastline.

It is therefore apparent that there are provided, in accordance with the various example implementations disclosed herein, systems and methods for modifying intensity of tropical cyclones or storms, which are also known as hurricanes, cyclones or typhoons, and/or altering their track or path across water bodies.

While the disclosed subject matter has been described in conjunction with a number of implementations, it is evident that many alternatives, modifications and variations would be or are apparent to those of ordinary skill in the applicable arts. Accordingly, Applicant intends to embrace all such alternatives, modifications, equivalents and variations that are within the spirit and scope of the disclosed subject matter.

### LIST OF REFERENCES

PAGE 1: (Ewa Jarosz, et al, Bottom-Up Determination of Air-Sea Momentum Exchange Under a Major Tropical Cyclone, Science Vol. 315, p 1707, 23 Mar. 2007.); (Leo H. Holthuijsen et al Journal of Geophysical Rearch, Vol. 117, C09003).
PAGE 2: Hurricanes: Science and Society; Hurricane Decay and Demise, The University of Rhode Island Graduate School of Oceanography)
PAGE 2: Rosenstiel School of Marine & Atmospheric Science, Frequent Question #4.).
PAGE 3: http://ww2010.atmos.uiuc.edu/(Gh)/wwhlpr/hurricane saffirsimpson.rxml
PAGE 4: Wikipedia, Tropical cyclone rainfall climatology
PAGE 7: Hurricanes: Tempests in a Greenhouse, FIG. 1: Physics Today: Vol. 59, No 8, 74.)
PAGE 7: Jarosz et al, Bottom-Up Determination of Air-Sea Momentum Exchange Under a Major Tropical Cyclone, Science, Vol. 315, p. 1707 23 Mar. 2007.)
PAGE 8: Brian McNoldy, Huffpost Dec. 6, 2017).
PAGE 8: Pseudo-momentum, Wiktionary
PAGE 9: “The response of damaging winds of a simulated tropical cyclone to finite amplitude perturbations of different variables”. J. Atmos. Sci., 63 (7), 1924 1937
PAGE 10: Physics Today: Vol 59, No. 8, 74
PAGE 10: p4 of 96 National Hurricane Center Tropical Cyclone Report—Hurricane Matthew (AL142016
PAGE 11: David Wang, Naval Research Laboratory
PAGE 13: Winds and waves in extreme hurricanes, Holthuijsen, Abstract, Journal of Geophysical Research, Vol. 117, issue C9, C09003
PAGE 14: What Happens Underwater During a Hurricane? Brian McNoldy, U of Miami's Rosenstiel School of Marine & Atmospheric Science, HUFFPOST Dec. 6, 2017
PAGE 14: Live Science Sep. 8, 2017, Curt Storlazzi, U.S. Geological Survey
PAGE 15: Encyclopedia of Climate and Weather, Hurricanes
PAGE 15: (https://www.nationalgeographic.org/encyclopedia/coriolis-effect/)
PAGE 18: Wind and waves in extreme hurricanes, Leo H. Holthuijsen, Mark D. Powell, Julie D. Pietrzak, J G R Oceans, Vol. 117, Issue C9, April 2012
PAGE 19: Wind and waves in extreme hurricanes, Holthuijsen, Journal of Geophysical Research, para 40-41
PAGE 19: Bottom Up Determination of Air-Sea Momentum Exchange under a Major Tropical Cyclone, Jarosz et al, Science Mar. 23, 2007, page 17
PAGE 20: https://phys.org/news/2017-02-breakthrough-vertical-axis-turbines.html#jCp, citing “Low order physical models of vertical axis wind turbines” Renewable and Sustainable Energy, Feb. 28, 2017. DOI: 10.1063/1.4976983
PAGE 21: (Quora, May 18, 2017, “Can a really rough sea sink an aircraft carrier?” Joe Shelton).
PAGE 21: Quora, Apr. 13, 2017, “What do aircraft carriers do in a storm?” Brian Bake
PAGE 22: The Effect of Weather On A Ship's Speed, Summary, C. S. Nilsson, 1977
PAGE 23: http://www.iawe.org/Proceedings/7APCWE/M3B 2.pdf
PAGE 24: Winds and waves in extreme hurricanes, Abstract, Journal of Geophysical Research, Vol. 117, issue C9, C09003).
Page 24: The damping of ocean waves by surface films: A new look at an old problem, 15 May 1989, Journal of Geophysical Research: Oceans/Vol. 94, Issue C5
PAGE 25: Xinan Liu, James H. Duncan, The effects of surfactants on spilling breaking waves, Nature 421, 520-523, 30 Jan. 2003
PAGE 26: Sourav De et al, A review on natural surfactants, RSV ADV. 2015, 5, 65757
PAGE 26: Putting the Brakes on the Hurricane Heat Engine, Trans NY Acad Sci 28, 1045, 1966
PAGE 27: Vessel speed over ground affected by extreme winds, 2^{nd} ed, Craig B. Smith, Wind and Wave Speed in Knots
PAGE 31: Increased Hurricane Intensity, Nick Bradford, https://www.neefusa.org/nature/water/increased-hurricane-intensity

### ADDITIONAL MATERIALS REVIEWED BUT NOT CITED IN THE SPECIFICATIONS

The Effect Of Weather On A Ship's Speed, C. S. Nilson, 1977, Chapter 10: Summary: The Model For Speed As A Function Of Weather
Wikipedia, Wave Power
Effect Of Surfactants On Global Co2 Flux, Tsai And Liu
A Review On Natural Surfactants, Sourav De Et Al, Rsc Adv. 2015, 5, 65757
Influence of natural surfactants on short wind waves in the coastal Peruvian waters, D. Kiefhaber, et al, Ocean Sci. Discuss., 12, 1291-1325, 2015
Wikipedia, Vertical axis wind turbine
Signs Of The Approaching Hurricane, Chap. VII, Signs of the Approaching Hurricane, Tannehill 1950
Extreme Wave Height Reports From Ndbc Buoys During Hurricane Sandy, March 2014
Hurricane Matthew, 28 Sep.-9 Oct. 2016, 7 Apr. 2017
The Effect Of The Physical Properties Of Water Surface On Initial Wind-Waves Generation Mechanism At Low Wind, Apcwe-Vii, 2009
Extreme Waves, Craig b. Smith 2^{nd} Ed. Wind Waves, Composite Waves
Eyewall Wind Profiles in Hurricanes Determined By GPS Dropwindsondes, James L. Franklin, Michael L. Black, and Krystal Valde, NOAA April 2000
Hurricanes: Science and Society, Interaction between a Hurricane and the Oceans
Hurricanes, 2^{nd} Ed., Patrick J Fitzpatrick
Hurricane Almanac, Bryan Norcross

What is claimed is:

1. A method for reducing intensity of a tropical cyclone, the method comprising:
deploying one or more of submarines or aircraft carriers in a water body below an outer eyewall of the tropical cyclone to reduce the capacity of the storm to intensify by one or more of:
mimicking a rising floor of the water basin,
distorting circular symmetry of the outer and/or inner eyewall of the storm and triggering periodic resynchronizations,
inducing short period wave action within the outer edge of the eyewall of the storm to increase wind resistance by deflecting revolving currents back up to a surface of the water body,
equipping the nuclear submarines with one or more water jet systems or air jet systems to facilitate stabilized navigation within strong rotating currents beneath hurricane eyewall wave crests and to cause the large mass and volume of the submarines to deflect the currents back up to the surface of the water body, and to undermine the foundational support otherwise provided for the extremely tall wave crests,
deploying aircraft carriers on an outer edge of an eyewall of the tropical storm at a leading quadrant of the tropical storm in order to impose wind resistance, or
using eyewall management techniques designed to prevent development of the tropical cyclone exceeding wind speeds of 90 mph by one of maintaining or restoring wind-resisting short period waves and preventing non-wind-resisting long period waves,
wherein the tropical cyclone or storm is one or more of a hurricane, a typhoon, or a cyclone.

2. The method of claim 1, further comprising:
causing enhanced wind resistance induced by erratic wave action at the 10 o'clock sector of the outer eyewall of the tropical storm to trigger an inward flattening of the eyewall of the tropical cyclone and divert a forward path of the storm to a rightward direction from an initial path of the storm in Earth's northern hemisphere.

3. The method of claim 2, further comprising:
causing a sustained diversion of wind stream of the outer eyewall of the tropical cyclone to reposition a center of an eye of the storm in the rightward direction and deflect a path of the storm to the rightward direction in the Earth's northern hemisphere.

4. The method of claim 1, further comprising:
causing enhanced wind resistance induced by erratic wave action at 2 o'clock sector of an inner eyewall of the tropical cyclone to trigger a localized flattening of the curvature of the eyewall of the tropical cyclone and divert a forward path of the storm to a rightward direction from an initial path of the storm in Earth's northern hemisphere.

5. The method of claim 4, further comprising:
causing a sustained diversion of wind stream of the inner eyewall of the tropical cyclone to reposition the center of an eye of the storm in the rightward direction and deflect a path of the storm to the rightward direction in the Earth's northern hemisphere.

6. The method of claim 1, further comprising:
inducing, using the submarines, erratic short period wave action within the outer eyewall of the tropical cyclone to increase wind resistance in corresponding portion of the outer eyewall of the storm;
reducing the capacity of the tropical cyclone to intensify by distorting the circular symmetry of the outer eyewall of the tropical storm; and
causing simultaneously and in a balanced manner enhanced wind resistance at the outer eyewall of the tropical cyclone via deployment of the submarines on diagonal paths crisscrossing one or more radii beneath the outer eyewall of the storm to reduce wind speeds and mitigate intensity of the storm without influencing a path of the storm.

7. The method of claim 1, further comprising:
inducing, using the submarines, erratic short period wave action within the outer eyewall of the tropical cyclone to increase wind resistance in corresponding portion of the outer eyewall of the storm;
reducing the capacity of the storm to intensify by distorting the circular symmetry of the outer eyewall of the storm; and
causing simultaneously and in a balanced manner enhanced wind resistance within the outer eyewall of the tropical cyclone via deployment of the submarines at off-setting leading sectors of a path of the storm, e.g., at 11 o'clock and at 1 o'clock to reduce wind speeds and mitigate intensity of the storm without influencing the path of the storm.

8. The method of claim 1, further comprising:
operating the submarines at an inner portion of an inner eyewall of the tropical cyclone at 2 o'clock to produce a flattening of the inner portion of the eyewall of the storm and deflecting a path of the storm to a rightward direction in the Earth's northern hemisphere.

9. The method of claim 1, further comprising:
operating the aircraft carriers at an inner portion of an inner eyewall of the tropical cyclone at 2 o'clock to produce an inward flattening of the inner portion of the eyewall of the storm and deflecting a path of the storm to a rightward direction in the Earth's northern hemisphere.

10. The method of claim 1, further comprising:
increasing wind resistance at an outer edge of the eyewall of the tropical cyclone using wind-absorbing and wind-slowing wind turbines installed on the aircraft carriers, wherein the wind-absorbing and the wind-slowing wind turbines turn on a vertical axis mounted on vertical columns.

11. The method of claim 1, further comprising:
causing enhanced wind resistance by wind turbines rotating on their vertical axis to trigger a deflection of an outer eyewall wind corridor resulting in a localized flattening of the eyewall of the tropical cyclone and a diversion of a path of the storm in a rightward direction from an initial path of the tropical cyclone in Earth's northern hemisphere.

12. The method of claim 11, further comprising:
causing a sustained diversion of the wind stream of the outer eyewall of the tropical cyclone to reposition the center of an eye of the storm in the rightward direction and deflect the path of the storm to the rightward direction in the Earth's northern hemisphere.

13. The method of claim 1 further comprising:
causing enhanced wind resistance at 2 o'clock sector of an inner portion of the eyewall of the tropical cyclone to trigger an inward flattening of the eyewall curvature and divert a forward path of the storm to a rightward direction from an initial path of the storm in Earth's northern hemisphere.

14. The method of claim 13, further comprising:
causing a sustained diversion of wind stream of the eyewall of the tropical cyclone to reposition a center of the eye in the rightward direction and deflect a path of the storm to the rightward direction in the Earth's northern hemisphere.

15. The method of claim 10, further comprising:
introducing simultaneously in a balanced manner enhanced wind resistance within the outer eyewall of the tropical cyclone via deployment of the aircraft carriers on diagonal paths crisscrossing within the eyewall of the storm to reduce wind speeds and mitigate storm intensity without influencing the path of the storm.

16. The method of claim 10, further comprising:
introducing simultaneously in a balanced manner enhanced wind resistance within the outer eyewall of the tropical storm via deployment of nuclear submarines or aircraft carriers at off-setting locations, e.g., at 11 o'clock and at 1 o'clock or at locations other than a leading sector on the current path of the tropical cyclone to reduce wind speeds and mitigate storm intensity without influencing the path of the tropical cyclone.

17. A method for modifying a path of a tropical cyclone across a water body, the method comprising:
manipulating the path of the tropical cyclone having an eyewall across a water body by one of deforming a circular shape of the eyewall of the tropical cyclone or imposing wind-resisting forces at an outer eyewall of one or more leading sectors of the storm in a direction of the path of the storm, wherein the storm is one or more of a hurricane, a typhoon, or a cyclone.

18. A method for one or more of modifying a path of a tropical cyclone or reducing intensity of the storm, the method comprising one or more of:
applying surfactants to a surface of a water body beneath the tropical cyclone, or introducing disruptive influences by deploying submarines within an outer eyewall of the tropical cyclone such that the submarines run one of abreast or inline on a staggered fashion on a parallel course beneath one of adjoining or nearby separated cyclonic storm wave crests,
wherein the tropical cyclone is, one or more of a hurricane, a typhoon, or a cyclone, and wherein the method disrupts a highly coordinated relationship between winds of the tropical storm and waves of the tropical storm running parallel to a circulation of the tropical storm to influence one or more of the tropical storm's path or intensity.

19. The method of claim 18, further comprising:
maintaining a course at a moderate angle of deflection towards an eye of the tropical storm to induce the directions of waves that are against and not in concert with a current direction of winds of the eyewall of the tropical cyclone.

20. The method of claim 18, wherein the application of the surfactants to the surface of the water body reduces wave height and increases wind resistance by restoring multi-directional waves in place of waves moving in concert with the wind.

21. The method of claim 18 further comprising:
The surfactant is applied within the eyewall of the cyclonic storm using nuclear submarines or nuclear aircraft carriers or other vessels capable of withstanding eyewall conditions, or
The surfactant is applied within the outer bands of the storm near the eyewall using any vessels capable of withstanding the conditions within the outer bands.

22. A method comprising:
when a cyclonic storm is located near a coast, the surfactant is applied within the right eyewall and/or within the outer bands of the right eyewall from remotely controlled fixed platforms optimally positioned offshore so as to protect the coastal areas vulnerable to storm surge, or
the surfactant is applied within the eyewall of the storm using vessels capable of withstanding eyewall conditions, and shallower depths, or
when a cyclonic storm is located near a coast, the surfactant is applied within the eyewall and within the outer bands of the storm using any vessels capable of withstanding eyewall conditions within the shallower depths.

23. A method comprising:
deploying environmentally acceptable surfactants to lower surface tension, wherein the environmentally acceptable surfactants are deployed offshore of one or more coastal cities in order to lower a wave height component of a storm surge,
wherein the environmentally acceptable surfactants serve to lower storm surge wave heights and also serve to lessen a capacity of a storm eyewall to raise a mean sea level component of a storm surge;
wherein the deploying includes construction of remotely controlled fixed stations to timely dispense the environmentally acceptable surfactants at effective distances from the coastline and with a suitable spacing between adjacent stations that is proportionate to the distance of the stations from the shore.

24. The method of claim 23, wherein deploying includes using vessels to disperse the environmentally acceptable surfactants, wherein the vessels are capable of safe offshore operations in the midst of fierce onshore winds and waves of a storm's eyewall and those of the storm bands of the storm's right quadrant.

25. The method of claim 23 wherein telescoping wind turbines turning on a vertical axis mounted offshore of coastal cities on the same fixed stations having the effect of slowing onshore surface winds and lessening both the wave height component and the mean sea level component of a storm surge.
